(19) United States
(12) Patent Application Publication
(10) Pub. No.: US 2025/0384876 A1
(43) Pub. Date: Dec. 18, 2025

(54) SPEECH SEPERATION DEVICE INCLUDING ASYMMETRIC ENCODER-DECODER

(71) Applicant: SOGANG UNIVERSITY RESEARCH & BUSINESS DEVELOPMENT FOUNDATION, Seoul (KR)

(72) Inventors: Hyung Min PARK, Seoul (KR); Ui Hyeop SHIN, Seoul (KR)

(21) Appl. No.: 19/194,169

(22) Filed: Apr. 30, 2025

(30) Foreign Application Priority Data
Jun. 13, 2024 (KR) 10-2024-0076723

(51) Int. Cl. G10L 15/16; G10L 15/04

(52) U.S. Cl. CPC G10L 15/16; G10L 15/04

(57) ABSTRACT

A speech separation device according to an embodiment of the present disclosure may include a separation encoder, a speaker separation unit, and a reconstruction decoder. The separation encoder may provide an encoded feature sequence by downsampling an input representation generated based on a speech signal. The speaker separation unit may provide a plurality of separated feature sequences by separating the encoded feature sequence for each of a plurality of speakers included in the speech signal. The reconstruction decoder may provide an output representation for each speaker by upsampling the separated feature sequence.

The speech separation device according to the present disclosure may not only improve system performance more effectively but also reduce system complexity by providing the plurality of separated feature sequences, each separated for the plurality of speakers, by using the speaker separation unit disposed between the encoder and the decoder.

### CROSS-REFERENCE TO RELATED APPLICATION(S)

This application claims benefit of priority to Korean Patent Application No. 10-2024-0076723 filed on 13 Jun. 2024 in the Korean Intellectual Property Office, the disclosure of which is incorporated herein by reference in its entirety.

### BACKGROUND

### 1. Field

The present disclosure relates to a speech separation device including an asymmetric encoder-decoder.

### 2. Description of Related Art

A speech extraction system may require complex computation to extract speech for each speaker from a speech signal in which a plurality of speakers are conversing in a single space. In recent years, various studies have been conducted to reduce system complexity required to extract the speech from the speech extraction system.

### RELATED ART DOCUMENT

### Patent Document

Korean Patent Laid-Open Publication No. 10-2023-0061016 (published on May 8, 2023)

### SUMMARY

An aspect of the present disclosure may provide a speech separation device capable of not only improving system performance but also reducing system complexity by providing a plurality of separated feature sequences, each separated for a plurality of speakers, by using a speaker separation unit disposed between an encoder and a decoder.

A speech separation device according to an embodiment of the present disclosure may include a separation encoder, a speaker separation unit, and a reconstruction decoder.

The separation encoder may provide an encoded feature sequence by downsampling an input representation generated based on a speech signal. The speaker separation unit may provide a plurality of separated feature sequences by separating the encoded feature sequence for each of a plurality of speakers included in the speech signal. The reconstruction decoder may provide an output representation for each speaker by upsampling the separated feature sequence.

The separation encoder may include a feature compression unit and a plurality of encoding stages, and the feature compression unit may provide an input feature sequence of a predetermined size based on the input representation.

Each of the plurality of encoding stages may further include a plurality of global-local transformers. The global-local transformer may provide a global-local encoding sequence generated based on all components included in a feature sequence input into each of the encoding stages and components included in a preset region corresponding to a predetermined region.

Each of the encoding stages may further include a convolution unit. The convolution unit may downsample the global-local encoding sequence.

An order between a global transformer and a local transformer may be switchable.

The feature sequence input into a first encoding stage among the plurality of encoding stages may be an input feature sequence provided by the feature compression unit.

Among the plurality of encoding stages, a final encoding stage may provide the encoded feature sequence to the speaker separation unit without the convolution unit.

The reconstruction decoder may include a plurality of decoding stages and a feature extension unit.

Each of the plurality of decoding stages may further include an upsampling unit. The upsampling unit may provide an upsampled sequence separated by upsampling each of a plurality of feature sequences input into each of the decoding stages.

Each of the plurality of decoding stages may further include a plurality of Siamese global-local transformers. The Siamese global-local transformer may provide each of global-local decoded sequences generated based on all components included in the plurality of feature sequences input into each of the decoding stages and components included in a preset region corresponding to a predetermined region.

An order between a Siamese global transformer and a Siamese local transformer may be switchable.

Each of the decoding stages may further include a cross-reconstruction transformer. The cross-reconstruction transformer may provide a reconstructed decoded sequence by extracting feature information among the speakers based on each of the global-local decoded sequences.

Among the plurality of decoding stages, the plurality of decoded input sequences of a first decoding stage may be the separated feature sequences.

The feature extension unit may provide the output representation based on an output feature sequence.

The output feature sequence transmitted to the feature extension unit may be a reconstructed decoded sequence provided by the cross-reconstruction transformer in a final decoding stage among the plurality of decoding stages.

The global-local encoding sequences output from the encoding stages other than the final stage may be provided to the speaker separation unit before passing to the convolution unit.

The speaker separation unit may provide the skip connections separated for each stage to the corresponding decoder stages based on the encoded global-local sequence for each stage.

Each of the plurality of decoding stages may further include a feature fusion unit. The feature fusion unit may provide a fused feature sequence based on the upsampled sequence provided by the upsampling unit and the separated skip connection provided by the speaker separation unit.

The fused feature sequence may be a feature sequence provided to the Siamese global transformer.

A speech separation device according to an embodiment of the present disclosure may include an audio encoder, a separation encoder, a speaker separation unit, a reconstruction decoder, and an audio decoder. The audio encoder may provide a two-dimensional input representation based on a one-dimensional mixed speech signal. The separation encoder may provide an encoded feature sequence by downsampling the input representation of the mixed speech signal. The speaker separation unit may provide a plurality of separated feature sequences by separating the encoding sequence for each of a plurality of speakers included in the speech signal. The reconstruction decoder may provide an output representation for each speaker by upsampling the separated feature sequence. The audio decoder may provide the plurality of one-dimensional separated speech signals based on the plurality of output representations.

The device may further include a loss calculation unit. The loss calculation unit may calculate a loss value based on the plurality of separated speech signals provided by the audio decoder.

The device may further include an auxiliary signal-and-auxiliary loss calculation unit. The auxiliary signal-and-auxiliary loss calculation unit may produce an auxiliary signal and an auxiliary loss value for each stage based on reconstructed decoded sequences provided from the plurality of decoding stages.

The auxiliary loss calculation unit may further include an auxiliary feature extension unit and an auxiliary audio decoder. The auxiliary feature extension unit may provide an auxiliary output representation based on the reconstructed decoded sequence of each of the decoding stages other than the final stage. The auxiliary audio decoder may provide a separated auxiliary speech signal based on the plurality of auxiliary output representations.

The auxiliary loss calculation unit may produce the auxiliary loss value for each stage based on the plurality of separated auxiliary speech signals, and the auxiliary loss value for each stage may be accumulated together with the loss value.

The device may learn parameters (weights) of the audio encoder, separation unit, and audio decoder based on the accumulated loss value.

In a method for operating a speech separation device according to an embodiment of the present disclosure, a separation encoder may provide an encoded feature sequence by downsampling an input representation of a mixed speech signal. A speaker separation unit may provide a plurality of separated feature sequences by separating the encoded feature sequence for each of a plurality of speakers included in the speech signal. A reconstruction decoder may provide an output representation for each speaker by upsampling the separated feature sequence.

In a method for operating a speech separation system, an audio encoder may provide a two-dimensional input representation based on a one-dimensional mixed speech signal. A separation encoder may provide an encoded feature sequence by downsampling an input representation. A speaker separation unit may provide a plurality of separated feature sequences by separating the encoded feature sequence for each of a plurality of speakers included in the speech signal. A reconstruction decoder may provide an output representation for each speaker by upsampling the separated feature sequence. An audio decoder may provide a plurality of one-dimensional separated speech signals based on the plurality of output representations.

In addition to the above-mentioned technical tasks of the present disclosure, other features and advantages of the present disclosure may be described below, or may be clearly understood by those skilled in the art to which the present disclosure pertains from such description and explanation.

### BRIEF DESCRIPTION OF DRAWINGS

FIG. 1 is a view showing a speech separation device according to an embodiment of the present disclosure.

FIG. 2 is a view showing a separation encoder included in the speech separation device in FIG. 1.

FIG. 3 is a view showing an encoding stage included in the separation encoder of the speech separation device in FIG. 1.

FIG. 4 is a view showing a final encoding stage included in the separation encoder of the speech separation device in FIG. 1.

FIG. 5 is a view showing a global-local transformer included in the encoding stages in FIGS. 3 and 4.

FIGS. 6 and 7 are views showing a speaker separation unit included in the speech separation device in FIG. 1.

FIG. 8 is a view showing a reconstruction decoder included in the speech separation device in FIG. 1.

FIG. 9 is a view showing a decoding stage included in a reconstruction encoder of the speech separation device in FIG. 1.

FIG. 10 is a view showing a Siamese global-local transformer included in the decoding stage in FIG. 9.

FIG. 11 is a view showing a cross-reconstruction transformer included in the decoding stage in FIG. 9.

FIG. 12 is a view describing an embodiment of the speech separation device in FIG. 1.

FIG. 13 is a view showing a speech separation system according to an embodiment of the present disclosure.

FIG. 14 is a view describing a loss calculation unit included in the speech separation system in FIG. 13.

FIG. 15 is a view showing an auxiliary signal-and-auxiliary loss calculation unit in FIG. 14.

FIG. 16 is a view showing an auxiliary loss stage included in the auxiliary signal-and-auxiliary loss calculation unit in FIG. 15.

FIG. 17 is a flowchart showing a method for operating a speech separation device according to an embodiment of the present disclosure.

FIG. 18 is a flowchart showing a method for operating a speech separation system according to an embodiment of the present disclosure.

### DETAILED DESCRIPTION

In the specification, in adding reference numerals to components throughout the drawings, it should be noted that like reference numerals designate like components even though components are shown in different drawings.

Meanwhile, meanings of the terms described in this specification should be understood as follows.

A term of a singular number may include its plural number unless explicitly indicated otherwise in the context, and a scope of the present disclosure is not limited by the terms used herein.

It should be understood that a term “include” or “have” does not preclude the presence or addition of one or more other features, numerals, operations, components, parts or combinations thereof, which is mentioned in the specification.

Hereinafter, embodiments of the present disclosure are described in detail with reference to the accompanying drawings.

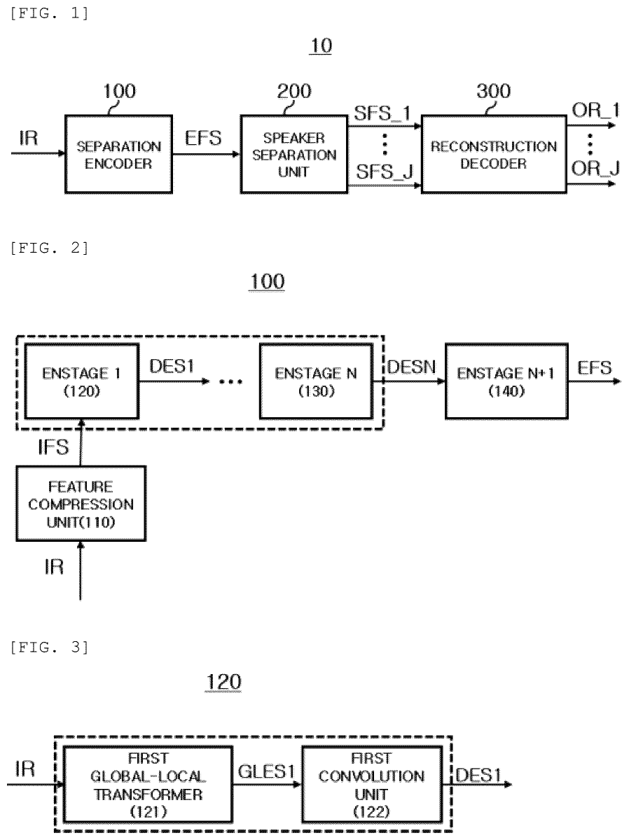

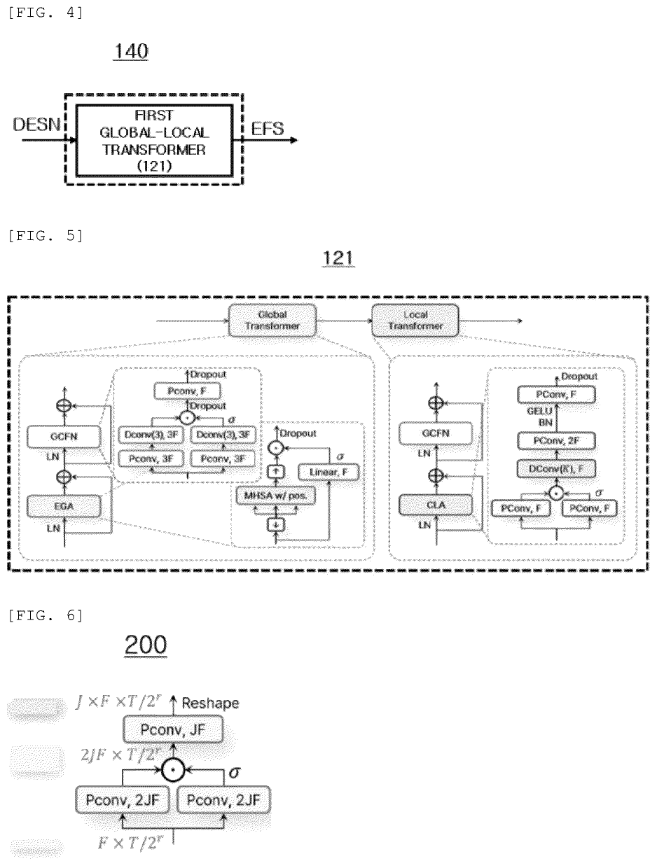

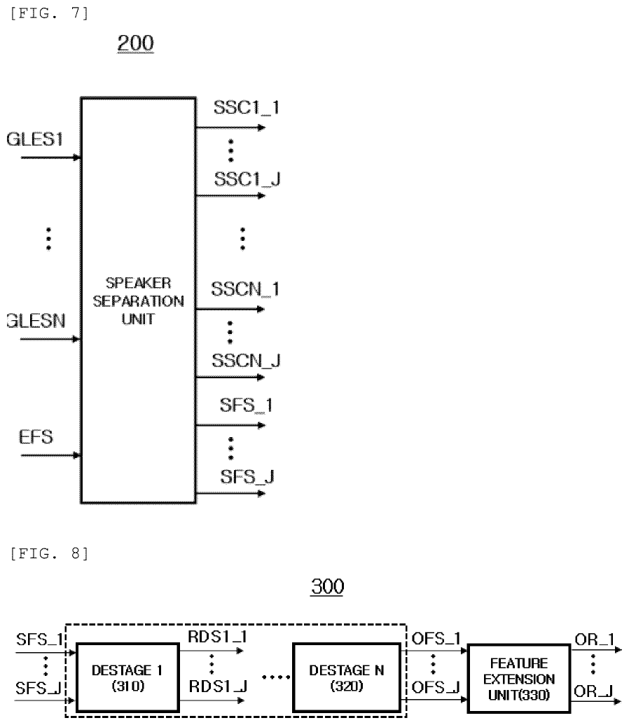

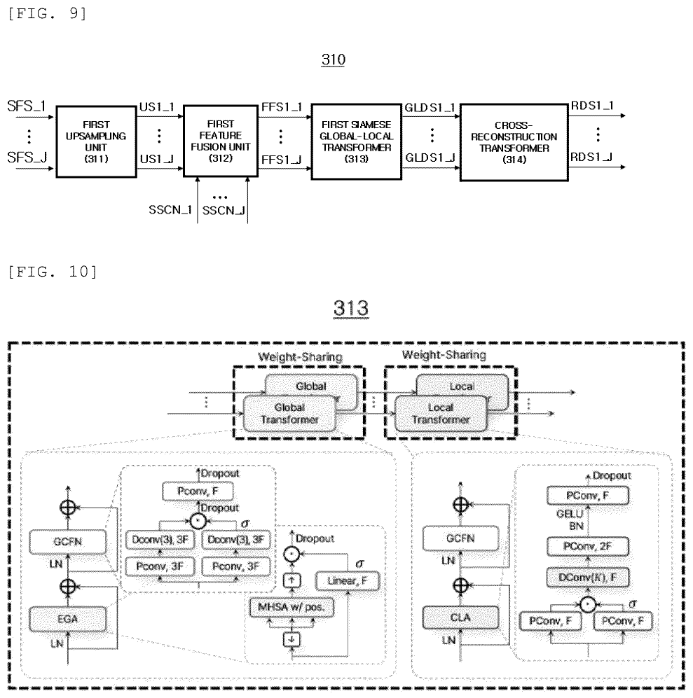

FIG. 1 is a view showing a speech separation device according to an embodiment of the present disclosure; FIG. 2 is a view showing a the separation encoder included in the speech separation device in FIG. 1; FIG. 3 is a view showing an encoding stage included in the separation encoder of the speech separation device in FIG. 1; FIG. 4 is a view showing a final encoding stage included in the separation encoder of the speech separation device in FIG. 1; FIG. 5 is a view showing a global-local transformer included in the encoding stages in FIGS. 3 and 4; and FIGS. 6 and 7 are views showing a speaker separation unit included in the speech separation device in FIG. 1.

Referring to FIGS. 1 to 7, a speech separation device 10 according to an embodiment of the present disclosure may include a separation encoder 100, a speaker separation unit 200, and a reconstruction decoder 300. The separation encoder 100 may provide an encoded feature sequence EFS by downsampling an input representation IR in which time-based frames T, generated based on a mixed speech signal MS, are represented for each channel F₀.

In an embodiment, the separation encoder 100 may include a feature compression unit 110. For example, the feature compression unit 110 may compress the channels based on the number of channels F set for the input representation IR input to the separation encoder, thereby providing an input feature sequence IFS in which the frames T based on time are expressed for each compression channel F.

In an embodiment, the separation encoder 100 may include the plurality of encoding stages. For example, the plurality of the encoding stages may include a first encoding stage 120 to an N+1-th encoding stage 140. Each of the first encoding stage 120 to the N+1-th encoding stage 140 may be connected to each other in a cascade manner.

Each of the plurality of encoding stages may further include the global-local transformer. For example, the first encoding stage 120 among the plurality of encoding stages may include a first global-local transformer 121. Here, the description describes the first encoding stage 120, and the description above may be equally applied to the first encoding stage 120 to the N+1-th encoding stage 140.

As shown in FIGS. 3 to 5, the global-local transformer may provide a global-local encoding sequence GLES generated based on all components included in a sequence input into each of the encoding stages and components included in a preset region corresponding to a predetermined region. In an embodiment, the sequence input into the first encoding stage 120 among the plurality of the encoding stages may be the input feature sequence IFS transmitted from the feature compression unit 110. For example, the first encoding stage 120 may receive the input feature sequence IFS transmitted to the feature compression unit 110. In this case, an encoding input sequence of the first encoding stage 120 may be the input feature sequence IFS.

In an embodiment, each of the encoding stages may further include a convolution unit. The convolution unit may downsample the global-local encoding sequence GLES. The plurality of the encoding stages may include the first encoding stage 120 to an N-th encoding stage 130. For example, the first encoding stage 120 may include a first convolution unit 122, and the first convolution unit 122 may receive a first global-local encoding sequence GELS1 and downsample the same to provide a first downsampled output DES1. In this case, the first downsampled output DES1 may be an input sequence of a second encoding stage among the plurality of encoding stages. The third to the N-th encoding stage 130 may be operated in the same manner.

According to an embodiment, an N+1 encoding stage 140 may include no convolution unit. For example, the N+1 encoding stage may provide the encoded feature sequence EFS, which is an output of the separation encoder without downsampling.

As shown in FIG. 6, the speaker separation unit 200 may provide a plurality of separated feature sequences SFS by separating the encoded feature sequence EFS for each of a plurality of speakers J included in the mixed speech signal MS. For example, the plurality of speakers J may include a first speaker to a J-th speaker, and the speaker separation unit 200 may receive the encoded feature sequence EFS and separate and provide a first separated feature sequence SFS 1 corresponding to the first speaker to a J-th separated feature sequence SFS_J corresponding to the J-th speaker.

As shown in FIG. 7, the speaker separation unit 200 may receive the global-local encoding sequence GLES for each encoding stage in addition to the encoded feature sequence EFS, and provide a plurality of separated skip connections SSC, each separated for the plurality of speakers J. For example, the speaker separation unit 200 may receive a first global-local encoding sequence GLES1 provided from the first encoding stage 120 and separately provide a first separated first-stage skip connection SSC1-1 corresponding to the first speaker to a J-th separated first-stage skip connection SSC1_J corresponding to the J-th speaker.

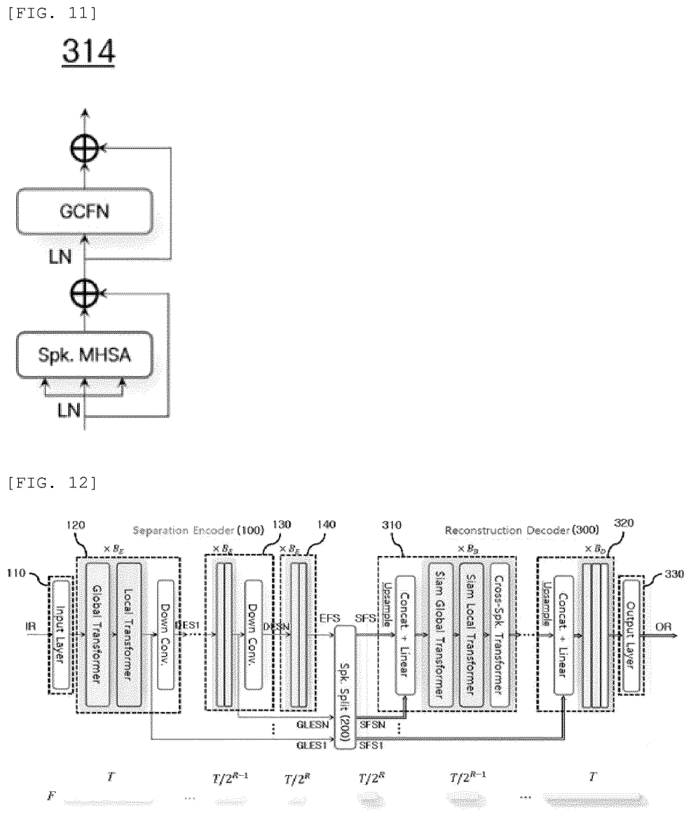

FIG. 8 is a view showing the reconstruction decoder included in the speech separation device in FIG. 1; FIG. 9 is a view showing a decoding stage included in a reconstruction encoder of the speech separation device in FIG. 1; FIG. 10 is a view showing a Siamese global-local transformer included in the decoding stage in FIG. 9; and FIG. 11 is a view showing a cross-reconstruction transformer included in the decoding stage in FIG. 9.

Referring to FIGS. 1 to 11, the decoder 300 may provide an output representation OR for each speaker by upsampling the separated feature sequences SFS.

In an embodiment, the decoder 300 may include the plurality of decoding stages and a feature extension unit 330. For example, the plurality of decoding stages may include a first decoding stage 310 to an N-th decoding stage 320. Each of the first decoding stage 310 to the N-th decoding stage 320 may be connected to each other in the cascade manner.

In an embodiment, each of the plurality of decoding stages may further include an upsampling unit. The upsampling unit may provide an upsampled sequence by upsampling each of a plurality of decoded input sequences input into each of the decoding stages. For example, the plurality of decoding stages may include the first decoding stage 310 to an N-th decoding stage 330. Among the plurality of decoding stages, a first upsampling unit 311 included in the first decoding stage 310 may receive the first separated feature sequence SFS_1 to the J-th separated feature sequence SFS_J as the decoded input sequence. The upsampling unit 311 may upsample the first separated feature sequence SFS_1 to the J-th separated feature sequence SFS_J to produce a first separated first-stage upsampled sequence US1_1 to a J-th separated first-stage upsampled sequence US1_J.

In an embodiment, each of the plurality of decoding stages may further include a feature fusion unit. The feature fusion unit may provide a fused feature sequence based on each of the corresponding upsampled sequences and each of the separated feature sequences received from the speaker separation unit 200. For example, the plurality of decoding stages may include the first decoding stage 310 to the N-th decoding stage 330. Among the plurality of stages, a first feature fusion unit 312 included in the first decoding stage 310 may provide a first separated first-stage fused feature sequence FFS1_1 to a J-th separated first-stage fused feature sequence FFS1_J based on the first separated first-stage upsampled sequence US1_1 to the J-th separated first-stage upsampled sequence US1_J and a first separated N-th stage skip connection SSCN_1 to a J-th separated N-th stage skip connection SSCN_J received from the speaker separation unit 200. More accurate upsampling may be achieved by enabling an N-th stage feature sequence SFSN, transmitted from the speaker separation unit 200 based on an N-th global-local encoding sequence GLESN, to be utilized in the first decoding stage 310.

In an embodiment, each of the plurality of decoding stages may include a plurality of Siamese global-local transformers. As shown in FIG. 10, each of the plurality of Siamese transformers may provide a global-local decoded sequence generated based on each corresponding fused feature sequence by sharing parameters (weight-sharing). For example, a first Siamese global-local transformer 313 included in the first decoding stage 310 may receive the first separated first-stage fused feature sequence FFS1_1 to the J-th separated first-stage fused feature sequence and process the received sequences in the same manner. The first Siamese global-local transformer 313 may then provide a first separated first-stage global-local decoded sequence GLDS1_1 global-local decoded to a J-th separated first-stage sequence GLDS1_J output therefrom.

In an embodiment, each of the decoding stages may further include the cross-reconstruction transformer. The cross-reconstruction transformer may provide a plurality of separated reconstructed decoded sequences by extracting feature information among the speakers J based on J-separated decoded sequences. For example, a first separated first-stage reconstructed decoded sequence RDS1_1 to a J-th separated first-stage reconstructed decoded sequence RDS1_J may be outputs produced by the Siamese global-local transformer based on the channel F (or frequency) and the frame T (or time). In this case, inter-speaker features may not be considered. To address this issue, the cross-reconstruction transformer may be used to consider the feature among the first speaker to the J-th speaker. In this case, outputs from a first cross transformer 314 may be the first separated first-stage reconstructed decoded sequence RDS1_1 corresponding to the first speaker to the J-th separated first-stage reconstructed decoded sequence RDS1_J corresponding to the J-th speaker. Here, the first separated first-stage reconstructed decoded sequence RDS1_1 to the J-th separated first-stage reconstructed decoded sequence RDS1_J may be transmitted as inputs to the second decoding stage. In addition, the content described above describes the first decoding stage 310 as an example. However, this content may be equally applied to the second decoding stage to the N-th decoding stage 320.

In an embodiment, the plurality of decoded input sequences from the first decoding stage 310 among the plurality of decoding stages may be the separated feature sequences SFS. For example, the plurality of speakers J may include the first speaker to the J-th speaker. In this case, the first decoding stage 310 among the plurality of decoding stages may receive the first separated feature sequence SFS_1 corresponding to the first speaker to the J-th separated feature sequence SFS_J corresponding to the J-th speaker as the decoded input sequences.

In an embodiment, the feature extension unit 330 may provide a first separated output representation OR 1 to a J-th separated output representation OR J based on a first separated output feature sequence OFS_1 to a J-th separated output feature sequence OFS_J.

In an embodiment, the output feature sequence OFS transmitted to the feature extension unit 330 may be the reconstructed decoded sequence provided by the cross-reconstruction transformer in the N-th decoding stage 320 among the plurality of decoding stages.

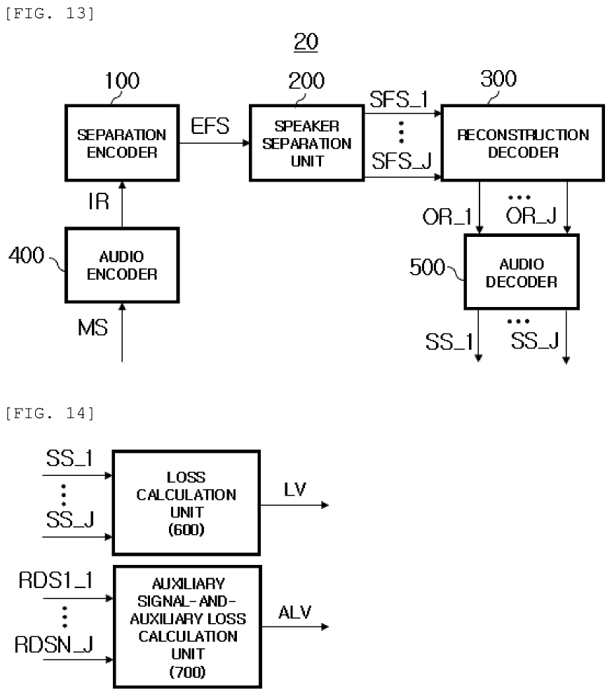

FIG. 12 is a view describing an embodiment of the speech separation device in FIG. 1; and FIG. 13 is a view showing a speech separation system according to an embodiment of the present disclosure.

Referring to FIGS. 1 to 13, to address such an issue, the speech separation system according to an embodiment of the present disclosure may include an audio encoder 400, the separation encoder 100, the speaker separation unit 200, the reconstruction decoder 300, and an audio decoder 500. The audio encoder may provide the input representation IR based on the mixed speech signal MS. The separation encoder 100 may provide the encoded feature sequence EFS by downsampling the input representation IR. The speaker separation unit 200 may provide the plurality of separated feature sequences SFSs, which are feature sequences separated for each of the plurality of speakers J included in the mixed speech signal MS. The reconstruction decoder 300 may provide the output representation OR for each speaker by upsampling the separated feature sequences SFS. The audio decoder 500 may provide a speech signal SS for each speaker based on each of the plurality of output representations OR.

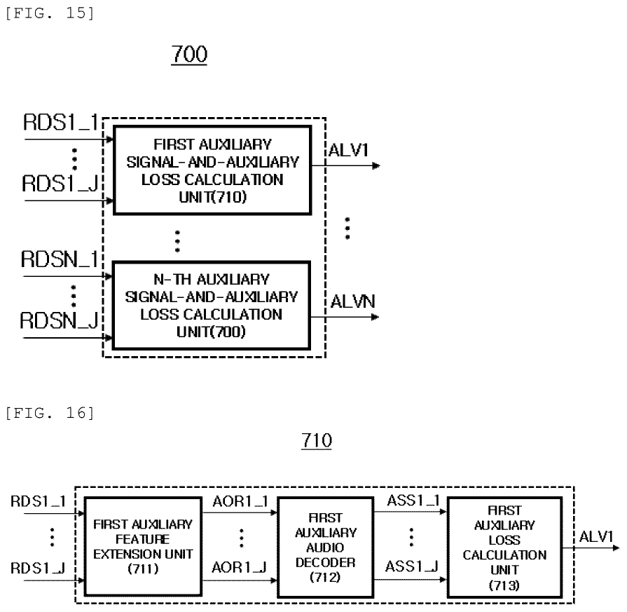

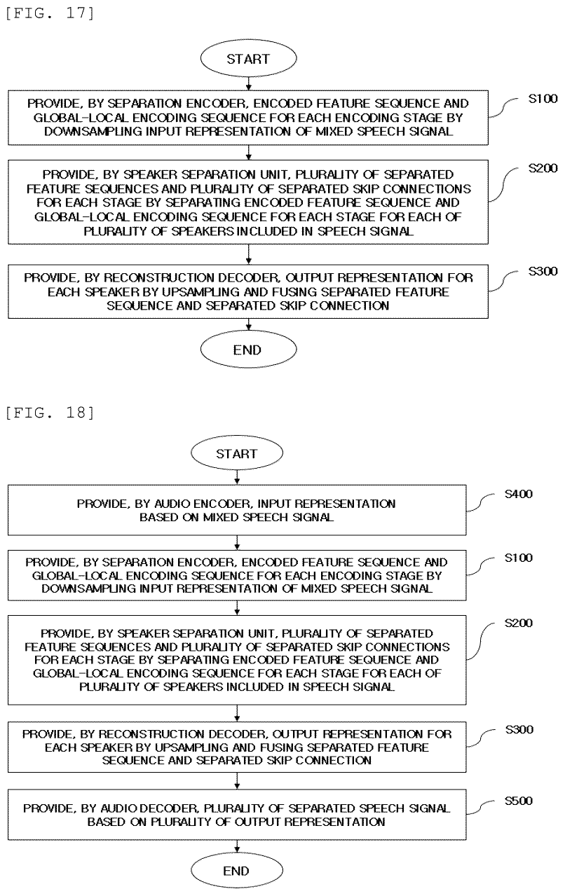

FIG. 14 is a view describing a loss calculation unit included in the speech separation system in FIG. 13; FIG. 15 is a view showing an auxiliary signal-and-auxiliary loss calculation unit in FIG. 14; and FIG. 16 is a view showing an auxiliary loss stage included in the auxiliary signal-and-auxiliary loss calculation unit in FIG. 15.

Referring to FIGS. 1 to 16, in an embodiment, a speech separation system 20 may further include a loss calculation unit 600 and an auxiliary signal-and-auxiliary loss calculation unit 700. The loss calculation unit 600 may produce a loss value LV based on an output of the speech signal SS for each speaker.

For example, the loss value LV may be produced as shown in [Equation 1] below.

$$ℒ = - {\sum }_{j = 1}^{J} min ( 20 {log}_{10} \frac{{‖ {γ}_{j} {s}_{j} ‖}_{2}}{{‖ {γ}_{j} {s}_{j} - {\hat{s}}_{j} ‖}_{2}} \text{?} τ ) \qquad [ Equation 1 ]$$

$$\text{?} \text{indicates text missing or illegible when filed}$$

Here, [symbol] indicates the loss value ŝⱼ, indicates an Here, output of the speech signal SS for each speaker, sⱼ indicates an original speech signal for each speaker, γⱼ indicates a correction value to scale the original speech signal with the speech signal SS for each speaker that is output from the system, and [symbol] indicates a clipped value for limiting the loss value.

In an embodiment, the auxiliary signal-and-auxiliary loss calculation unit 700 may configure the loss calculation unit of each stage based on an output from each decoding stage. For example, an auxiliary loss value ALV may be calculated as the sum of a first auxiliary loss value ALV1 to an N-th auxiliary loss value ALVN. As shown in FIG. 15, a first auxiliary signal-and-auxiliary loss calculation unit 710 may produce the first-stage auxiliary loss value ALV1 from the first-stage reconstructed decoded sequences RDS1 provided from the first decoding stage.

In an embodiment, each stage of the plurality of auxiliary signal-and-auxiliary loss calculation unit may include an auxiliary feature extension unit, an auxiliary audio decoder, and an auxiliary loss calculation unit. The feature extension unit of each stage may provide an auxiliary output representation based on the reconstructed decoded sequence received from the corresponding decoding stage. For example, a first auxiliary feature extension unit 711 included in the first auxiliary signal-and-auxiliary loss calculation unit 710 may provide an auxiliary output representation AOR based on the reconstructed decoded sequence RDS1 received from the first decoding stage.

In an embodiment, the auxiliary audio decoder of each stage may provide an auxiliary speech signal for each speaker based on the auxiliary output representation received from the auxiliary feature extension unit. For example, a first auxiliary audio decoder 712 included in the first auxiliary signal-and-auxiliary loss calculation unit 710 may provide a first auxiliary speech signal ASS1 for each speaker based on an auxiliary output representation AOR1 received from the first auxiliary feature extension unit 711.

In an embodiment, the auxiliary loss calculation unit of each stage may produce the auxiliary loss value of each stage based on an output of the auxiliary speech signal for each speaker. For example, the first-stage auxiliary loss value ALV1 may be produced based on the first auxiliary speech signal ASS1 for each speaker that is transmitted from the first auxiliary audio decoder 712.

For example, an r-th auxiliary loss value ALVr may be calculated as shown in [Equation 2] below.

$${ℒ}_{r} = - {\sum }_{j = 1}^{J} min ( 20 {log}_{10} \frac{{‖ {γ}_{j , r} {s}_{j} ‖}_{2}}{{‖ {γ}_{j , r} {s}_{j} - {\hat{s}}_{j , r} ‖}_{2}} \text{?} τ ) \qquad [ Equation 2 ]$$

$$\text{?} \text{indicates text missing or illegible when filed}$$

Here, [symbol] ^{r} indicates the r-th auxiliary loss value ALVr, ŝ_{j,r} indicates an output of an r-th auxiliary speech signal ASSr for each speaker, sⱼ indicates the original speech signal for each speaker, γ_{j,r} indicates a correction value to scale the original speech signal with the r-th auxiliary speech signal ASSr for each speaker of the system, and [symbol] indicates the clipped value for limiting the loss value.

In an embodiment, a final loss value FLV for training the speech separation system 20 may be produced from the loss value LV and the auxiliary loss value ALV.

For example, the final loss value FLV may be produced as shown in [Equation3] below.

$$\hat{ℒ} = ( \text{?} - α ) ℒ + α {\sum }_{r = 1}^{R} {ℒ}_{r} / R \text{?} \qquad [ Equation 3 ]$$

$$\text{?} \text{indicates text missing or illegible when filed}$$

Here, [symbol] indicates the final loss value FLV, α indicates a loss weight, [symbol] indicates the loss value LV produced from the output speech signal SS, [symbol] ᵣ indicates the r-th auxiliary loss value ALVr produced from a sequence of the auxiliary speech signal ASSr for each decoding stage, and R indicates the number of the decoding stage.

In an embodiment, the speech separation system 20 may learn parameters based on the final loss value FLV. For example, when learning the parameters included in the speech separation system 20 by using the auxiliary loss value ALV produced from the plurality of decoding stages, system performance may be better than using the loss value LV produced only by an output of an existing decoder. This performance may be implemented by disposing the speaker separation unit 200 between the encoder 100 and the decoder 300.

In an embodiment, the r-th auxiliary value ALVr may be produced based on a value of a short-time Fourier transformer STFT of the corresponding signal rather than the speech signal. In addition, the r-th auxiliary value ALVr may be produced based on a magnitude value of a complex STFT signal that excludes its phase information. This configuration is possible because the auxiliary signal is not a signal to be actually provided by the speech separation system 20. More stable learning is possible when the auxiliary loss value is produced using the magnitude value of the STFT of such a signal than when the auxiliary loss value is produced using the speech signal.

FIG. 17 is a flowchart showing a method for operating a speech separation device according to an embodiment of the present disclosure.

Referring to FIGS. 1 to 17, to address such an issue, in a method for operating a speech separation device 10 according to an embodiment of the present disclosure, the separation encoder 100 may provide the encoded feature sequence EFS and the global-local encoding sequence GLES for each stage by downsampling input representation generated based on the mixed speech signal MS (S100). The speaker separation unit 200 may provide the plurality of separated feature sequences SFS and the plurality of separated skip connections SSC for each stage by separating the encoded feature sequence EFS and the global-local encoding sequence GLES for each stage for each of the plurality of speakers J included in the speech signal SS (S200). The reconstruction decoder 300 may provide the output representation OR for each speaker by upsampling and fusing the separated feature sequence SFS and the separated skip connection SSC (S300).

FIG. 18 is a flowchart showing a method for operating a speech separation system according to an embodiment of the present disclosure.

Referring to FIGS. 1 to 18, to address such an issue, in a method for operating a speech separation system 20 according to an embodiment of the present disclosure, the audio encoder 400 may provide the input representation based on the mixed speech signal MS (S400). The separation encoder 100 may provide the encoded feature sequence EFS by downsampling the input representation of the mixed speech signal (S100). The speaker separation unit 200 may provide the plurality of separated feature sequences SFS, each separated for the plurality of speakers J included in the speech signal SS, and the plurality of separated skip connections SSC for each stage by separating the encoded feature sequence EFS and the global-local encoding sequence GLES for each stage (S200). The reconstruction decoder 300 may provide the output representation OR for each speaker by upsampling and fusing the separated feature sequence SFS and the separated skip connection SSC (S300). The audio decoder 500 may provide the speech signal SS for each speaker based on the output representation OR (S500).

In the method for operating the speech separation system 20 according to the present disclosure, the speaker separation unit 200 disposed between the separation encoder 100 and the reconstruction decoder 300 may be used to provide the plurality of encoded feature sequence SFS separated for each of the plurality of speakers J. As a result, the basic loss value LV and the auxiliary loss value ALV for each stage may be more effectively produced to allow the system to learn the parameters included in the system, thereby improving the system performance and reducing the system complexity.

As set forth above, the present disclosure as described above may provide the following effects.

According to the present disclosure, it is possible to not only improve the system performance but also reduce the system complexity by providing the plurality of separated feature sequences, each separated for the plurality of speakers, by using the speaker separation unit disposed between the encoder and the decoder.

In addition, other features and advantages of the present disclosure may be newly identified through the embodiments of the present disclosure.

What is claimed is:

1. A speech separation device comprising:
a separation encoder configured to provide an encoded feature sequence by downsampling an input representation generated based on a speech signal;
a speaker separation unit configured to provide a plurality of separated feature sequences by separating the encoded feature sequence for each of a plurality of speakers included in the speech signal; and
a reconstruction decoder configured to provide an output representation for each speaker by upsampling the separated feature sequence.

2. The device of claim 1, wherein the separation encoder includes a feature compression unit and a plurality of encoding stages, and
each of the plurality of encoding stages further includes a global-local transformer configured to provide a global-local encoding sequence generated based on all components included in an encoding input sequence input into each of the encoding stages and components included in a preset region corresponding to a predetermined region.

3. The device of claim 2, wherein each of the encoding stages further includes a convolution unit configured to downsample an output of the global-local encoding sequence.

4. The device of claim 3, wherein the encoding input sequence of a first encoding stage among the plurality of encoding stages is an input feature sequence provided by the feature compression unit.

5. The device of claim 4, wherein the feature compression unit outputs the input feature sequence based on the input representation.

6. The device of claim 5, wherein the speaker separation unit provides separated skip connection sequences to a corresponding decoding stage based on the global-local encoding sequence.

7. The device of claim 6, wherein the decoder includes the plurality of decoding stages and a feature extension unit, and
each of the plurality of decoding stages further includes an upsampling unit configured to provide a upsampled sequence by upsampling each of a plurality of decoded input sequences input into each of the decoding stages.

8. The device of claim 7, wherein each of the plurality of decoding stages further includes a feature fusion unit configured to provide a plurality of fused feature sequences based on the respective upsampled sequences and the separated skip connection provided by the speaker separation unit.

9. The device of claim 8, wherein each of the plurality of decoding stages includes a plurality of Siamese global-local transformers each configured to provide an output of a global-local decoded sequence generated based on each fused feature sequence.

10. The device of claim 9, wherein each of the decoding stages further includes a cross-reconstruction transformer configured to provide a reconstructed decoded sequence by extracting feature information among the speakers based on an output of a decoding transformer of each of the Siamese global-local transformers.

11. The device of claim 10, wherein among the plurality of decoding stages, the plurality of decoded input sequences of a first decoding stage are the separated feature sequences.

12. The device of claim 11, wherein the feature extension unit is configured to provide the output representation generated based on the plurality of decoded feature sequences provided from an N-th decoding stage among the plurality of decoding stages.

13. A speech separation system comprising:
an audio encoder configured to provide an input representation based on a mixed speech signal;
a separation encoder configured to provide an encoded feature sequence by downsampling the input representation;
a speaker separation unit configured to provide a plurality of separated feature sequences by separating the encoded feature sequence for each of a plurality of speakers included in the speech signal;
a decoder configured to provide an output representation for each speaker by upsampling the separated feature sequence; and
an audio decoder configured to provide a speech signal for each speaker based on the output representation.

14. The system of claim 13, further comprising a loss calculation unit configured to calculate a loss value and an auxiliary loss value based on the sequences provided from the output representation and a plurality of decoding stages.

15. The system of claim 14, wherein the loss calculation unit further includes an auxiliary feature extension unit and an auxiliary audio decoder each configured to provide an auxiliary signal to produce the auxiliary loss value based on the sequences provided from the decoding stages.

16. The system of claim 15, wherein a parameter (weight) applied to the speech separation system is adjusted based on the loss value and the auxiliary loss value.

17. A method for operating a speech separation device, the method comprising:
providing, by a separation encoder, an encoded feature sequence and a global-local encoding sequence for each encoding stage by downsampling an input representation generated based on a mixed speech signal;
providing, by a speaker separation unit, a plurality of feature sequences separated and separated skip connections by separating the encoded feature sequence and the global-local encoding sequences for each stage for each of a plurality of speakers included in the speech signal; and
providing, by a reconstruction decoder, an output representation for each speaker by upsampling and fusing the separated feature sequence and the separated skip connection.

18. A method for operating a speech separation system, the method comprising:
providing, by an audio encoder, an input representation based on a mixed speech signal;
providing, by a separation encoder, an encoded feature sequence and a global-local encoding sequence for each encoding stage by downsampling an input representation generated based on the mixed speech signal;
providing, by a speaker separation unit, a plurality of separated feature sequences and separated skip connections by separating the encoded feature sequence and the global-local encoding sequence for each stage for each of a plurality of speakers included in the speech signal;
providing, by a reconstruction decoder, an output representation for each speaker by upsampling and fusing the separated feature sequence and the separated skip connection; and
providing, by an audio decoder, a speech signal separated for each speaker based on the output representation for each speaker.
